(19) United States
(12) Patent Application Publication
(10) Pub. No.: US 2011/0294512 A1
(43) Pub. Date: Dec. 1, 2011

(54) SYSTEM AND METHOD FOR ROUTING PUSH-TO-TALK CALLS

(75) Inventors: Safwan A. Khan, Centreville, VA (US); Fnu Rajan, Bowie, MD (US)

(73) Assignee: NII HOLDINGS, INC., Reston, VA (US)

(21) Appl. No.: 13/131,889

(22) PCT Filed: May 27, 2010
(86) PCT No.: PCT/US10/36310

§ 371 Date: May 31, 2011

(51) Int. Cl. H04W 40/20

(52) U.S. Cl. 455/445

(57) ABSTRACT

A call routing apparatus is provided, comprising: a call handler configured to receive a call request from an origin handset in a local region, and to route call information from the origin handset to a destination handset in the local region, the call request including a destination handset identifier that identifies the destination handset, the destination handset identifier including a region identifier; a region core configured to determine whether the destination handset is in the local region or a remote region based on the region identifier; a provisioning system configured to determine routing information based on the region identifier if the region identifier identifies the remote region, the routing information including data necessary for routing the call to the remote region; and a gateway configured to route the call request to a remote gateway in a remote region based on the destination handset identifier and the routing information.

### FIELD OF THE INVENTION

The present claimed invention relates in general to call routing in a push-to-talk (PTT) communication system. More specifically it relates to a system and method by which calls in a PTT communication system can be routed more efficiently across different geographical, operational, and technological regions.

### BACKGROUND OF THE INVENTION

Push-to-talk (PTT) is a communication regime in which two or more handsets (e.g., cell phones) can enter into half-duplex communication with each other, where only one party can transfer voice data at a time, rather than full duplex communication in which multiple parties can transmit voice data at the same time. In this way PTT operates similar to walkie-talkies in which one person must push a button to claim the air space to talk and then release it to allow the other party the option to push the corresponding button on their handset to pass their voice over the transmission medium.

PTT can be cheaper to operate since half-duplex communication is typically simpler to operate than full duplex, and less greedy of bandwidth. Also, PTT typically offers a quicker connection protocol, allowing for more instantaneous and casual conversations.

Currently there is no one common protocol for using PTT over cellular networks. One protocol is the integrated digital enhanced network (iDEN) protocol; another is the international mobile telecommunications-2000 (IMT-2000) family of standards, also known as the Third Generation or 3G standards. Because of the multiplicity of standards, PTT communication between two networks using different technology is not currently possible.

However, it would be desirable to provide a way by which systems of differing technologies were able to communicate with each other. Furthermore, because simplicity is important for customer satisfaction, it would be further desirable if this communication were possible to connect with another user using only their current telephone number, including country or region code. And because connection time is always an issue, it would be desirable to provide a system that can make such a connection in a short period of time.

It would therefore be desirable to provide a system and method for routing a call in which a user can connect to another handset in under two seconds, regardless of where or in what system the handset is in by simply entering in that handset's telephone number.

### SUMMARY OF THE INVENTION

A call routing apparatus, is provided, comprising: a call handler configured to receive a call request from an origin handset in a local region, and to route call information from the origin handset to a destination handset in the local region, the call request including a destination handset identifier that identifies the destination handset, the destination handset identifier including a region identifier; a region core configured to determine whether the destination handset is in the local region or a remote region based on the region identifier; a provisioning system configured to determine routing information based on the region identifier if the region identifier identifies the remote region, the routing information including data necessary for routing the call to the remote region; and a gateway configured to route the call request to a remote gateway in a remote region based on the destination handset identifier and the routing information. The call routing apparatus may further comprise a routing database configured to store the routing information.

The call request may be a request to initiate a push-to-talk communication connection. The routing information may include domain information for the remote region. The local region may be one of: a geographic region, a functional region, and a technological region. In particular, the local region is a local country and remote region is a remote country.

Alternatively, the local region may be one of: an International Mobile Telecommunications-2000 cellular telephone region, and an Integrated Digital Enhanced Network (iDEN) cellular telephone network, while the remote region may be the other of the International Mobile Telecommunications-2000 cellular telephone region, and the Integrated Digital Enhanced Network (iDEN) cellular telephone network.

The call routing apparatus may further comprise: a state database configured to contain routing information adjustment data.

A method for routing a push-to-talk call, is provided comprising: determining that a push-to-talk button has been activated to indicate that a call has been initiated; receiving a destination handset identifier, the destination handset identifier identifying a destination handset, the destination handset identifier including a region identifier; determining whether the region identifier identifies a local region or a remote region; routing the call to the destination handset in the local region based on the destination handset identifier if the region identifier identifies the local region; determining remote routing information based on the region identifier if the region identifier identifies the remote region, the remote routing information including data necessary for routing the call to the remote region; and routing the call to a remote gateway in the remote region based on the destination handset identifier and the remote routing information if the region identifier identifies the remote region.

The method may further comprise: routing the call to a local gateway before the operation of determining the routing information, if the remote region identifier identifies the remote region.

The routing information may include domain information for the remote region. The local region may be one of: a geographic region, a functional region, and a technological region. For example, the local region may be a local country and the remote region may be a remote country. Alternatively, the local region may be one of: an International Mobile Telecommunications-2000 cellular telephone region, and an Integrated Digital Enhanced Network (iDEN) cellular telephone network, while the remote region may be the other of the International Mobile Telecommunications-2000 cellular telephone region, and the Integrated Digital Enhanced Network (iDEN) cellular telephone network.

The method may further comprise: receiving an indication from the remote gateway that the destination handset is not in the remote region; determining an alternate region; determining alternate routing information, the alternate routing information including data necessary for routing the call to an alternate region; and routing the call to an alternate gateway in the alternate region based on the destination handset identifier and the alternate routing.

In this method, latency from when the push-to-talk button has been activated to when a call is successfully routed to the destination handset may be less than two seconds.

The operation of determining the remote routing information may further include: determining basic routing information based on the region identifier; and determining modified routing information based on whether the destination device has moved away from its home region. In this case, the call may be routed to the remote gateway in the remote region based on the destination handset identifier, the remote routing information, and the modified routing information.

A method for routing a push-to-talk call is provided, comprising: determining that a push-to-talk button has been activated to indicate that a call has been initiated; receiving a destination handset identifier, the destination handset identifier identifying a destination handset, the destination handset identifier including a region identifier identifying a different technological region; determining remote routing information based on the region identifier, the remote routing information including data necessary for routing the call to the remote region; routing the call to a remote gateway in the remote region based on the destination handset identifier and the remote routing information if the region identifier identifies the remote region; receiving modified routing information from the remote gateway; and routing the call to the destination handset in the local region based on the destination handset identifier and the modified routing information.

### BRIEF DESCRIPTION OF THE DRAWINGS

The accompanying figures where like reference numerals refer to identical or functionally similar elements and which together with the detailed description below are incorporated in and form part of the specification, serve to further illustrate an exemplary embodiment and to explain various principles and advantages in accordance with the present invention.

FIG. 1 is a block diagram of a communication network according to disclosed embodiments;

FIG. 2 is a system flow diagram showing call routing according to a first disclosed embodiment;

FIG. 3 is a system flow diagram showing call routing according to a second disclosed embodiment;

FIG. 4 is a system flow diagram showing call routing according to a third disclosed embodiment;

FIG. 5 is a block diagram of a communication network according to a fourth disclosed embodiment;

FIG. 6 is a system flow diagram showing call routing according to the fourth disclosed embodiment;

FIG. 7 is a flow chart showing a call routing operation according to a disclosed embodiment; and

FIG. 8 is a flow chart showing a call routing operation according to another disclosed embodiment.

### DETAILED DESCRIPTION

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, may be supported with or in integrated circuits (ICs). It is expected that one of ordinary skill, notwithstanding possibly significant effort and many design choices motivated by, for example, available time, current technology, and economic considerations, when guided by the concepts and principles disclosed herein will be readily capable of generating such ICs with minimal experimentation. Therefore, in the interest of brevity and minimization of any risk of obscuring the principles and concepts according to the present invention, further discussion of such ICs will be limited to the essentials with respect to the principles and concepts used by the exemplary embodiments.

Call Routing Apparatus

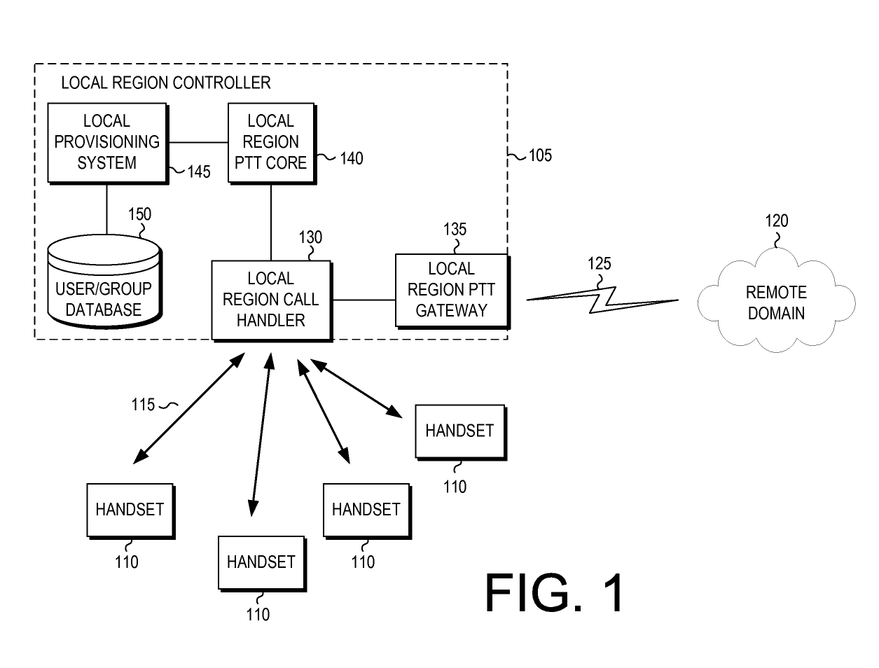

FIG. 1 is a block diagram of a communication network according to disclosed embodiments. As shown in FIG. 1, the communication network 100 includes a local region controller 105, a plurality of calling handsets 110 connected to the local region controller 105 by corresponding local wireless connections 115, and a remote domain 120 connected to the local region controller 105 by a remote connection 125. The local region controller 105 further includes a local region push-to-talk (PTT) gateway 130, a local region call handler 135, a local region PTT core 140, a local provisioning system 145, and a user/group database 150.

The local region controller 105 controls the routing of calls between handsets located in the local region. If can do so using any suitable communications protocol that supports PTT. This includes, but is not limited to, the Integrated Digital Enhanced Network (iDEN) standard, and any standard that meets the International Mobile Telecommunications-2000 (IMT-2000) (“3rd Generation” or “3G”) specification.

The plurality of calling handsets 110 are mobile devices that are equipped with PTT capabilities. They can be cellular telephones or any other mobile device that allows PTT operations through a local region controller.

The local wireless connections 115 are connections using the technology supported by the local region controller 105.

The remote domain 120 represents any remote location, not in the local region, which one of the plurality of calling handsets 110 may potentially enter in to communications with. This can include, but is not limited to, different geographical regions, different technological regions, or different operational regions. A different geographical region could be a country, a state, a city, or any other suitable geographical region. A different technological region could be an iDEN region, a 3G region, or any other region that employs a different technology for facilitating PTT operations. A different operational region could be any other sort of region for which a plurality of handsets are identified. This could include a large company, a government, or any other group that is serviced by a single region controller.

Typically, each separate domain (e.g., the local domain and the plurality of remote domains) will be identified by a region identifier unique to that region. In some embodiments, this region identifier can be an urban identifier (“urban ID”) or universal fleet member identifier (“UFMI”) assigned to that region. For example, Table 1 discloses the UFMIs that are associated with a number of countries within a Nextel 3G network.

TABLE 1
UFMI's by Country for 3G Network

| UFMI | Country (Region) |
|---|---|
| 51 | Peru |
| 52 | Mexico |
| 54 | Argentina |
| 55 | Brazil |
| 56 | Chile |

The remote domain is supported by one or more remote region controllers (not shown) that operated in a manner comparable to the local region controller. Therefore, a specific description of these remote region controllers will not be provided.

The remote connection 125 represents the means by which a local region controller and a remote region controller communicate. This can be any suitable wired or wireless communications link.

The local region PTT gateway 130 coordinates with the local region call handler 135 and operates to send and receive information to and from the remote domain. In this way, it facilitates the routing of PTT calls to any device not in the local region. Typically, the local region PTT gateway 130 will communicate with a counterpart remote region PTT gateway that will facilitate the PTT call at the remote end. Since different regions may use different technological formats, the local region PTT gateway 130 (and other region PTT gateways) facilitate the routing of calls in a manner that allows communication between the differing formats.

The local region call handler 135 operates to send and receive information to and from the plurality of handsets 110 in the local region. It performs this operation using the technological format supported by the local region (e.g., 3G, iDEN, etc.), and can do so using one or more base stations and relaying antennas.

The local region call handler 135 typically has a local cache (not shown) that includes routing information for all of the plurality of handsets 110 in the local region. Thus, when one handset 110 in the local region desires to place a PTT call to another handset 110 in the local region, the local region call handler 135 can obtain whatever routing information it requires to route the call from the local cache.

Although described as a “call handler,” this element could also be referred to as a “dispatcher,” or any other device that performs this function. In a 3G network, the device that performs this function is called a “call handler.” In an iDEN network, the device that performs this function is called a dispatcher. Other networks may employ different terminology.

The local region PTT core 140 is a control unit that operates to retrieve routing information required by the local region call handler 135 and the local region PTT gateway 130 for routing a PTT call to a handset in the remote domain. It

The local provisioning system 145 controls the operation of the user/group database 150, coordinating the storage of routing data, the updating of the routing data, and the forwarding of routing data to the local region PTT core 140 upon request.

In various embodiments, the local region PTT core 140 and the local provisioning system 145 can be implemented in a single microprocessor controller, though alternate embodiments could employ separate devices.

The user/group database 150 includes routing information necessary to route PTT calls to a remote region in the remote domain 120. In some embodiments this can be as simple as domain information for the remote regions, as shown in Table 2. In other embodiments, this can include information regarding where devices in the local region are roaming, and protocols for when and how to look for roaming handsets in regions other than their home region. The user/group database 150 could be more generally referred to as a local region database.

TABLE 2
Routing Information

| Country | | |
|---|---|---|
| (Region) | UFMI | Domain |
| Peru | 51 | @peru.com |
| Mexico | 52 | @mexico.com |
| Argentina | 54 | @argentina.com |
| Brazil | 55 | @brazil.com |
| Chile | 56 | @chile.com |

When a local handset 110 desires to communicate with a remote handset in a remote region in the remote domain 120, the local region call handler coordinates the call with respect to the local handset 110. But it routes the call to the remote domain 120 through the local region PTT gateway 130 using routing information obtained by the local region PTT core 140 and the local provisioning system 145 from the user/group database 150.

By maintaining the user/group database 150 in the local region controller 105, this system 100 allows the user of a handset 110 to place a call to another handset using only a simple handset identifier for the destination handset. In many cases, this handset identifier will simply be the telephone number of the destination handset, including country (i.e., region) code. With the user/group database 150, routing can be done quickly (e.g., within two seconds) and without the handset user having to either know or enter any additional routing information. Furthermore, this can be done regardless of the whether or not the destination handset uses a different technology than the origin handset. For example, it will allow relatively quick routing for a 3G phone requesting PTT operations with an iDEN phone, providing both support PTT operations.

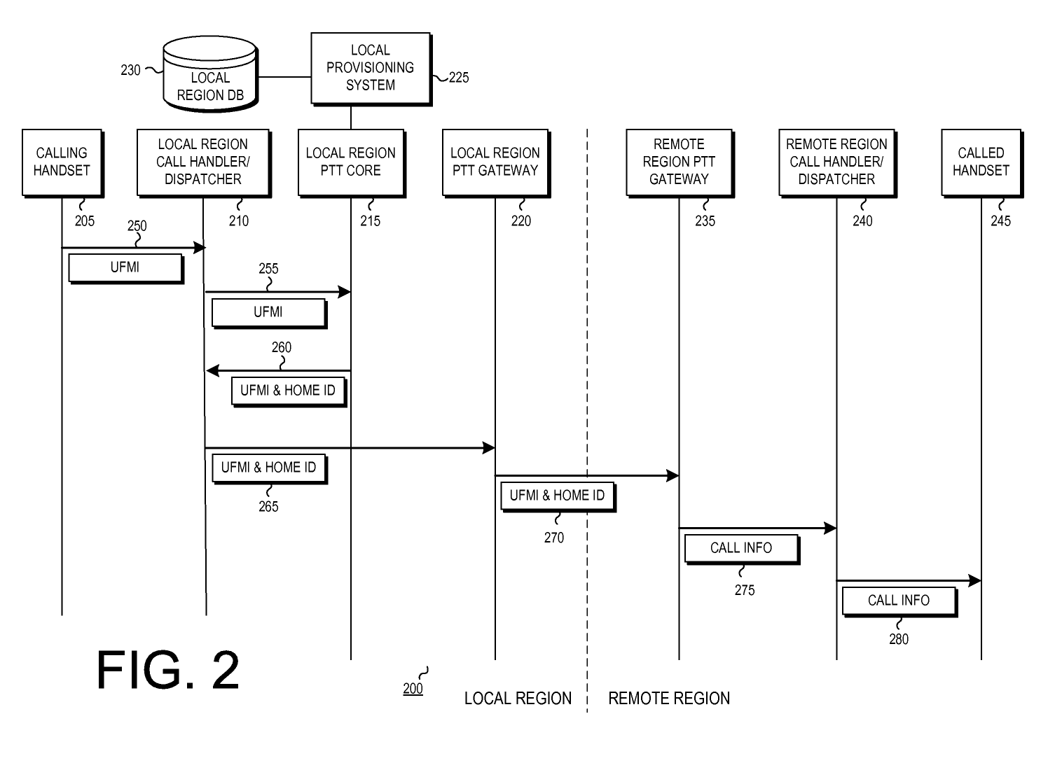

FIG. 2 is a system flow diagram showing call routing 200 according to a first disclosed embodiment. In this embodiment, a calling handset is in a local region, while a called handset is in a remote region to which it is assigned.

As shown in FIG. 2, the call routing 200 begins when a calling handset 205 (i.e., a source handset) sends a request for a PTT call 250 to a local region call handler/dispatcher 210. Here, the request for a PTT call 250 includes a region identifier, such as a UFMI.

The local region call handler/dispatcher 210 first determines whether the region identifier identifies the local region. If so, it routes the call within the local region. However, if the region identifier identifies a remote region, the local region call handler/dispatcher 210 forwards the PTT request 255 to the local region PTT core 215. Again, the PTT call request 255 includes the region identifier (e.g., the UFMI).

Having received a call request for a handset outside of the local region, the local region PTT core 215 then refers to a local provisioning system 225 and a local region database 230 for remote routing information necessary for the PTT call to be properly forwarded to a remote region.

The provisioning system 225 then returns a PTT call request 260 back to the local region call handler/dispatcher 210. However, in this PTT call request 260, the provisioning system 225 includes the remote routing information (e.g., a home ID for the destination region that has been identified as containing the destination handset). In some embodiments, this remote routing information can include the domain information of the remote region that has been identified as containing the destination handset.

The local region call handler/dispatcher 210 then forwards a PTT call request 265 (including the region identifier and remote routing information) to a local region PTT gateway 220, that forwards a similar a PTT call request 270 (also including the destination handset identifier and remote routing information) to a remote region PTT gateway 235 in the remote region. In this case, the remote routing information (e.g., the home ID) is typically used to properly direct the PTT call request 270 to the proper remote region PTT gateway 235.

The remote region PTT gateway 235 can then strip the remote routing information (which is now unnecessary) from the PTT call request 270 and send a simpler PTT call request 275 to the remote region call handler/dispatcher 240, including just the call information such as a handset identifier (e.g., the telephone number, excluding the UFMI).

The remote region call handler/dispatcher 240 is then able to route the call 280 to the called handset (i.e., the destination handset) using the call information received from the remote region PTT gateway 235, allowing the PTT connection to be completed.

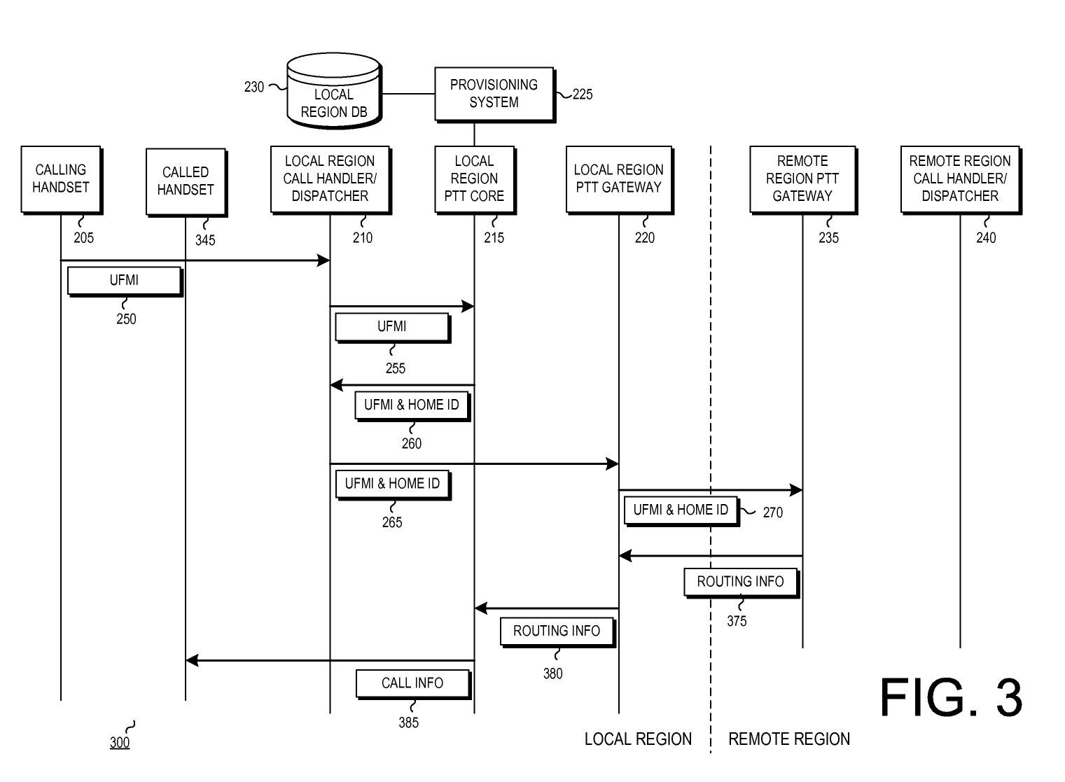

FIG. 3 is a system flow diagram showing call routing 300 according to a second disclosed embodiment. In this embodiment, both the calling handset and the called handset are in the local region. However, the called handset has a region identifier that is in a remote region. This can occur when a handset user moves to a new region, but because of telephone number portability, retains the old telephone number, including the old region identifier.

The change in region can reflect any kind of region change. For example, in one situation this could reflect a geographical change as a handset user moves from one location to another. A user that was originally in Brazil might move to Argentina, but keep his original telephone number, which includes an urban ID for Brazil. In another situation, this could reflect a change in technologies. A user might originally have an iDEN telephone, with a telephone number that includes a iDEN urban ID. IF the user changes to a 3G telephone, he may keep his original telephone number instead of getting a new one that uses a 3G urban ID. This may happen even if the user does not change geographical locations at all. Other changes in region could also occur in alternate embodiments.

As shown in FIG. 3, the call routing 300 begins as shown in the call routing 200 of FIG. 2. Similar operations are provided with the same reference number and will not be described separately.

The operation of the call routing 300 of FIG. 3 diverges from the call routing 200 of FIG. 2 when the call request is received 270 is received by the remote region PTT gateway 235. Here, the remote region PTT gateway 235 returns the call request 375 to the local region PTT gateway 220, and includes such routing information as is required to successfully route the call. This can include a notification to the local region that the user of the called handset has permanently moved, and a request to update the local regions records.

Once the local region PTT gateway 220 receives this call request 375, it forwards it to the local region call handler/dispatcher 210 as a call request 380.

The local region call handler/dispatcher 210 can then finally connect the PTT call 385 using call information generated at the local region call handler/dispatcher 210 and obtained from the call request 380. The local region call handler/dispatcher 210 may also update its internal cache (not shown) based on from the call request 380. This can include updating the required routing information for the called handset so that future calling operations are performed more quickly.

In this operation, a remote region call handler/dispatcher 240 is never contacted, since the called handset (i.e., the destination handset) is not in the remote region. In alternate embodiments, a call request may be forwarded deeper into the remote region (e.g., to remote region call handler/dispatcher 240 or a remote provisioning system) to determine the necessary routing information required to successfully route the call.

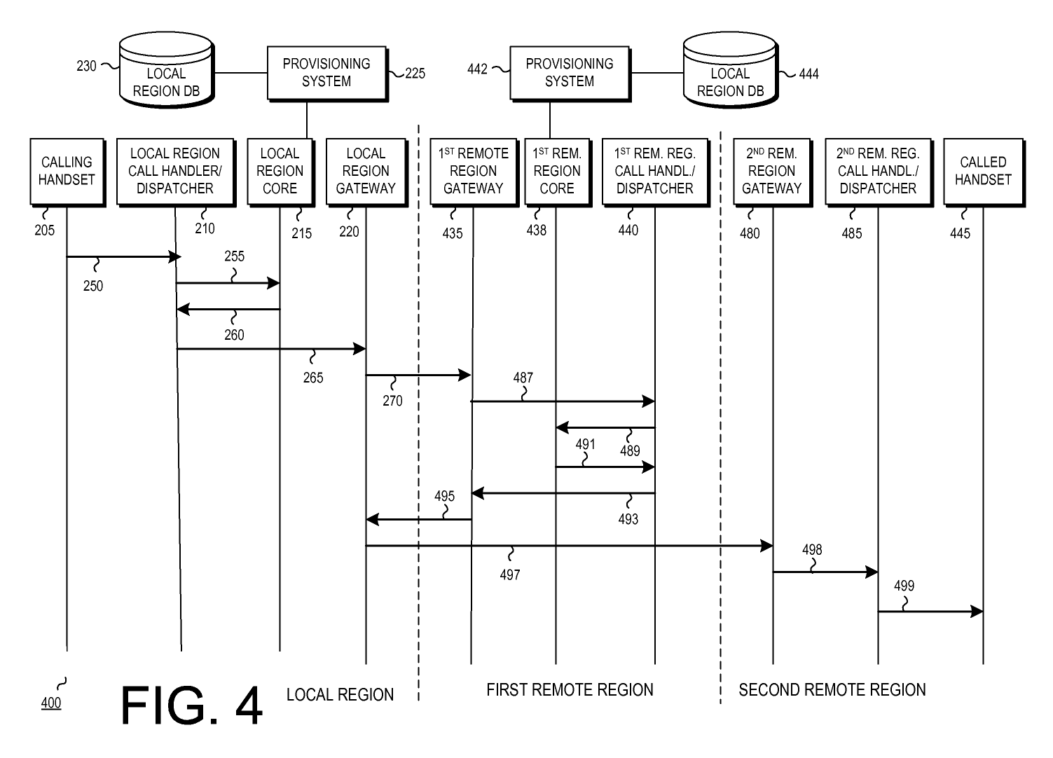

FIG. 4 is a system flow diagram showing call routing 400 according to a third disclosed embodiment. In this embodiment the called handset (i.e., the destination handset) is not currently in the region to which it is assigned (the first remote region), but is rather in a different remote region (a second remote region). This may be a result of a user roaming into the different remote region.

As shown in FIG. 4, the call routing 400 begins as shown in the call routing 200 of FIG. 2. Similar operations are provided with the same reference number and will not be described separately.

The operation of the call routing 400 of FIG. 4 diverges from the call routing 200 of FIG. 2 when the call request is received 270 is received by the first remote region PTT gateway 435, which sends a call request 487 to the first remote region call handler/dispatcher 440. The first remote region call handler/dispatcher 440 in turn sends a request for information 489 to the first remote region core and receives a response 491 providing routing information. Based on this information, the first remote region call handler/dispatcher 440 sends a call request 493 to the first remote region PTT gateway 435, which forwards it as a call request 495 to the local region gateway 220.

Then, having been informed that the called device 445 is not in the first remote region, the local region gateway 220 sends a call request 497 to a second remote region gateway 480 in a second remote region. This may be based on trial and error to see if the called handset 445 is in the second remote region. Alternatively, it may be based on information provided in the call request 495 received from first remote region PTT gateway 435.

The second remote region gateway 480 receives the call request 497, determines that either the called handset 445 is in the second remote region by checking a cache (not shown) and forwards a call request 498 to a second remote region call handler/dispatcher 485 for processing, or simply forwards the call request 498 for a determination of whether the called handset 445 is in the second remote region.

Finally, once the second remote region call handler/dispatcher 485 determines that the called handset is 445 in the second remote region, the second remote region call handler/dispatcher 485 routes the call 499 to the called handset 445 and completes the connection.

In an alternate embodiment, the first remote region call handler/dispatcher 440 can simply check in a local cache (not shown) to determine whether the called device is currently in the first remote region (e.g., whether it is roaming). In such embodiments, operations 489 and 491 may be omitted.

In some embodiments the call request 495 simply indicates that the called device is roaming, leaving it to a local region controller to determine whether to try an alternate region. In other embodiments, the call request can include information regarding what region the called handset is currently reported as roaming in.

Although FIG. 4 shows only two regions checked for the called handset 445, alternate embodiments could check a greater number of regions for the called handset 445. Typically, a primary restriction on such operations will be the desire to either connect the call or indicate a failure within a short period of time (e.g., 2 seconds).

In addition, although FIG. 4 describes a situation in which a called handset user has moved to a second remote region, different from the local region or the first remote reason, this operation is also applicable to a situation in which the called handset user has moved into the local region as well. For example, the called handset could be registered in a remote region, but the user is roaming into the local region. In this case, the operation of FIG. 4 would be the same, except that after the local region gateway 220 received the call request 495, it could seek the called handset in the local region, as shown above in operations 380 and 385 in FIG. 3. This could be done either based on trial and error or based on information received from the first remote region PTT gateway 435.

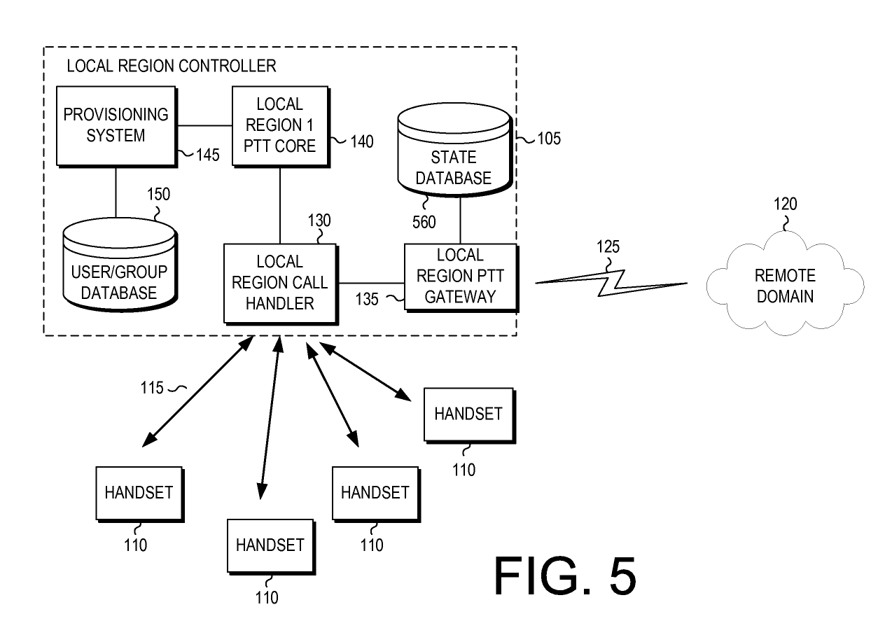

FIG. 5 is a block diagram of a communication network 500 according to a fourth disclosed embodiment. As shown in FIG. 5, the communication network 500 includes a local region controller 105, a plurality of calling handsets 110 connected to the local region controller 105 by corresponding local wireless connections 115, and a remote domain 120 connected to the local region controller 105 by a remote connection 125. The local region controller 105 further includes a local region push-to-talk (PTT) gateway 130, a local region call handler 135, a local region PTT core 140, a local provisioning system 145, a user/group database 150, and a state database 560.

The communication network 500 of FIG. 5 is similar to the communication network 100 of FIG. 1, with similar elements being identified by the same reference numerals. As a result, a description of these common elements is not provided.

The embodiment of FIG. 5 differs from that of FIG. 1 in that it contains a state database 560 connected to the local region PTT gateway 135.

The state database 560 allows the PTT gateway 135 to store information from a local storage cache to route calls. This may include information about roaming handsets, information about handsets whose region identifier does not match the regions they currently are based in, etc. By having this information in a state database 560 connected directly to the local region PTT gateway 135, accessing this information can be performed more quickly than if the user/group database 150 had to be queried, thus allowing for shorted connection times.

In various embodiments, the state database 560 could periodically share information with the user/group database 150, allowing for better information to be at each location, increasing the chance that the proper routing information will be found quickly.

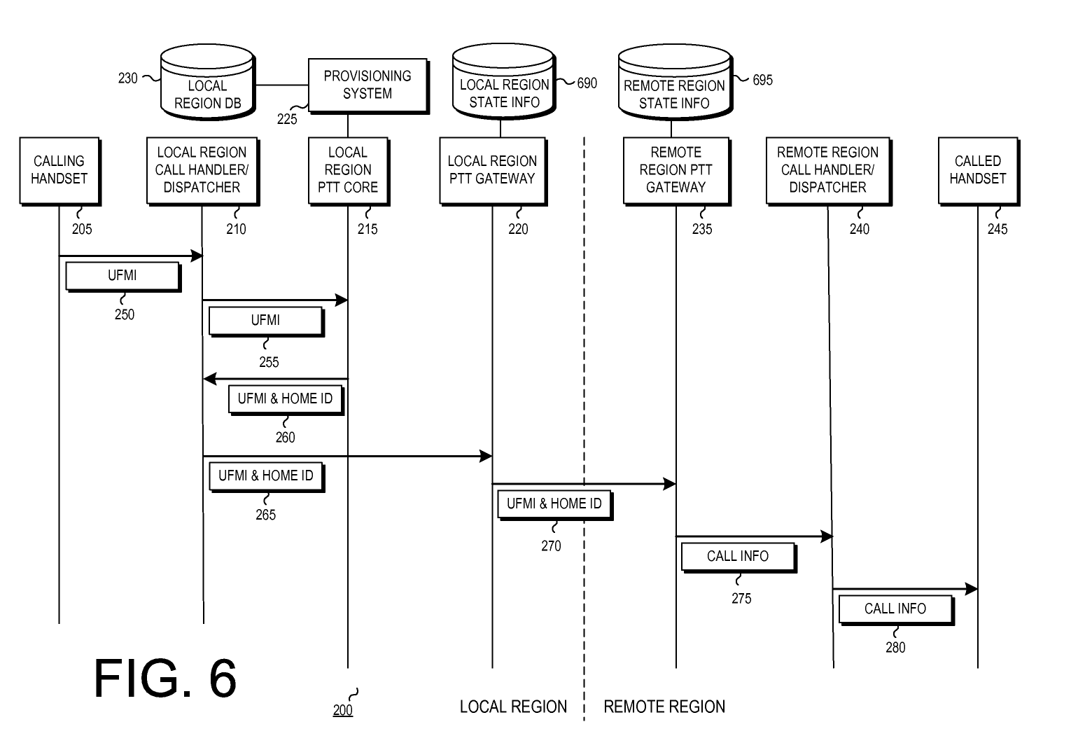

FIG. 6 is a system flow diagram showing call routing 600 according to the fourth disclosed embodiment. In this embodiment, the local region PTT gateway 220 is connected to a local region state information database 690 and the remote region PTT gateway 235 is connected to a remote region state information database 695.

As shown in FIG. 6, the call routing 600 proceeds essentially as shown in the call routing 200 of FIG. 2. Similar operations are provided with the same reference number and will not be described separately. However, in preparing the call requests 270 and 275, the local region PTT gateway 220 and the remote region PTT gateway 235 can access the local region state information database 690 and the remote region state information database 695, respectively.

In alternate embodiments, the remote region PTT gateway 235 may return the call request to the local region PTT gateway 220, as described above with respect to FIGS. 3 and 4. As shown in FIG. 6, in such embodiments, these operations can be performed while allowing the local region PTT gateway 220 and the remote region PTT gateway 235 can access the local region state information database 690 and the remote region state information database 695, respectively.

In the various embodiments disclosed above with respect to FIGS. 1-6, it is possible at any stage where new information is obtained for a current element to update status information based on the new information received. Embodiments that periodically update information in this way can help make future routing operations quicker.

Methods of Call Routing

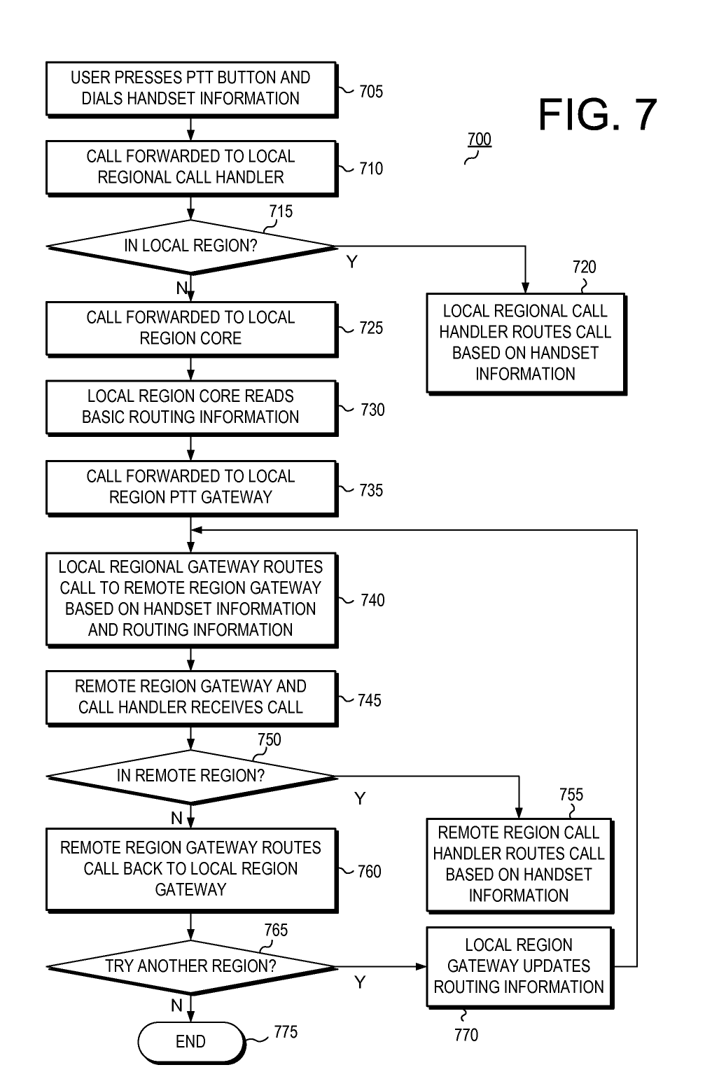

FIG. 7 is a flow chart showing a call routing operation 700 according to a disclosed embodiment. As shown in FIG. 7, the call routing operation 700 begins when the user presses a push-to-talk button on a calling handset (i.e., an origin handset) and dials handset information (e.g., a telephone number), including a region identifier (e.g., a universal fleet member identifier, UFMI.) that identifies a called handset (i.e., a destination handset). (705)

The call is then forwarded from the handset to a local region call handler. (710) The operation then determines whether the called handset is in the same local region as the calling handset. (715)

If the called handset is within the same local region as the calling handset, then the local region call handler routes the call based on the handset information. (720)

If, however, the called handset is not within the same local region as the calling handset, then the local region call handler forwards the call to a local region core (725), the local core reads routing information required to properly route the call (730), and the call is forwarded to the local region PPT gateway, typically through the first region call handler (735).

The local region gateway then routes the call to a remote region gateway based on the handset information and the routing information. (740)

A remote region gateway and remote region call handler then receives the call (745) and determines whether the called handset is currently in the remote region (750).

If the called handset is within the remote region, then the remote region call handler routes the call based on the handset information. (755)

If, however, the called handset is not within the remote region, then the remote region gateway routes the call back to the local region gateway (760).

The local region gateway then determines whether to try another region or not. (765) to see if it can find the called handset. This can be based on trial and error without any concrete knowledge, or it can be based on information received from the remote region gateway.

If the local region gateway determines that another region should be tried, then it updates the routing information to indicate the new region that should be tried (770) and repeats operations 740-765.

If the local region gateway determines that no other regions should be tried, then the connection process ends without a connection. In such a case, the local region controller may send an error message to the calling handset.

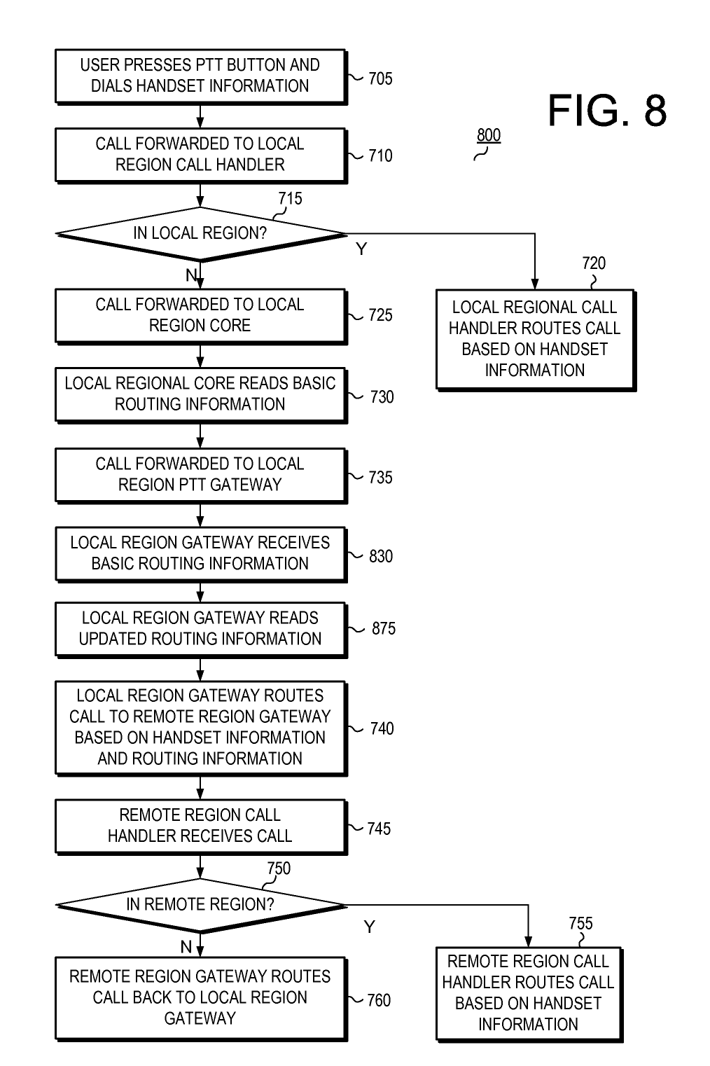

FIG. 8 is a flow chart showing a call routing operation 800 according to another disclosed embodiment. As shown in FIG. 8, the call routing operation 800 is similar to the call routing operation 700 of FIG. 7, and similar operations are identified with the same reference numeral. As a result, like operations will not be described.

The call routing operation 800 of FIG. 8 differs from the call routing operation 700 of FIG. 7 in that it allows the local region gateway to read updated routing information prior to the routing the call to the remote region gateway. (740)

In particular, the local region gateway receives basic routing information from the local region core. (830) This basic routing information is simply the routing information received in operation 730 above.

The local region gateway then reads updated routing information. (875) This updated routing information can come from a cache memory (e.g., a local state information database) proximate to the local region gateway, or any other memory element.

In this way, by allowing the local region gateway to maintain and read updated routing information, the speed and accuracy of the routing operation can be improved.

### CONCLUSION

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled. The various circuits described above can be implemented in discrete circuits or integrated circuits, as desired by implementation.

What is claimed is:

1. A call routing apparatus, comprising:
a call handler configured to receive a call request from an origin handset in a local region, and to route call information from the origin handset to a destination handset in the local region, the call request including a destination handset identifier that identifies the destination handset, the destination handset identifier including a region identifier;
a region core configured to determine whether the destination handset is in the local region or a remote region based on the region identifier;
a provisioning system configured to determine routing information based on the region identifier if the region identifier identifies the remote region, the routing information including data necessary for routing the call to the remote region; and
a gateway configured to route the call request to a remote gateway in a remote region based on the destination handset identifier and the routing information.

2. The call routing apparatus of claim 1, further comprising:
a routing database configured to store the routing information.

3. The call routing apparatus of claim 1,
wherein the call request is a request to initiate a push-to-talk communication connection.

4. The call routing apparatus of claim 1,
wherein the routing information includes domain information for the remote region.

5. The call routing apparatus of claim 1,
wherein the local region is one of: a geographic region, a functional region, and a technological region.

6. The call routing apparatus of claim 1,
wherein the local region is a local country and the remote region is a remote country.

7. The call routing apparatus of claim 1,
wherein the local region is one of: an International Mobile Telecommunications-2000 cellular telephone region, and an Integrated Digital Enhanced Network (iDEN) cellular telephone network.

8. The call routing apparatus of claim 7,
wherein the remote region is the other of the International Mobile Telecommunications-2000 cellular telephone region, and the Integrated Digital Enhanced Network (iDEN) cellular telephone network.

9. The call routing apparatus of claim 1, further comprising:
a state database configured to contain routing information adjustment data.

10. A method for routing a push-to-talk call, comprising:
determining that a push-to-talk button has been activated to indicate that a call has been initiated;
receiving a destination handset identifier, the destination handset identifier identifying a destination handset, the destination handset identifier including a region identifier;
determining whether the region identifier identifies a local region or a remote region;
routing the call to the destination handset in the local region based on the destination handset identifier if the region identifier identifies the local region;
determining remote routing information based on the region identifier if the region identifier identifies the remote region, the remote routing information including data necessary for routing the call to the remote region; and
routing the call to a remote gateway in the remote region based on the destination handset identifier and the remote routing information if the region identifier identifies the remote region.

11. The method for routing a push-to-talk call of claim 10, further comprising:
routing the call to a local gateway before the operation of determining the routing information, if the remote region identifier identifies the remote region.

12. The method for routing a push-to-talk call of claim 10,
wherein the routing information includes domain information for the remote region.

13. The method for routing a push-to-talk call of claim 10,
wherein the local region is one of: a geographic region, a functional region, and a technological region.

14. The method for routing a push-to-talk call of claim 10,
wherein the local region is a local country and the remote region is a remote country.

15. The method for routing a push-to-talk call of claim 10,
wherein the local region is one of: an International Mobile Telecommunications-2000 cellular telephone region, and an Integrated Digital Enhanced Network (iDEN) cellular telephone network.

16. The method for routing a push-to-talk call of claim 15,
wherein the remote region is the other of the International Mobile Telecommunications-2000 cellular telephone region, and the Integrated Digital Enhanced Network (iDEN) cellular telephone network.

17. The method for routing a push-to-talk call of claim 10, further comprising:
receiving an indication from the remote gateway that the destination handset is not in the remote region;
determining an alternate region;
determining alternate routing information, the alternate routing information including data necessary for routing the call to an alternate region; and
routing the call to an alternate gateway in the alternate region based on the destination handset identifier and the alternate routing.

18. The method for routing a push-to-talk call of claim 10, further comprising:
wherein a latency from when the push-to-talk button has been activated to when a call is successfully routed to the destination handset is less than two seconds.

19. The method for routing a push-to-talk call of claim 10,
wherein the operation of determining the remote routing information further includes:
determining basic routing information based on the region identifier; and
determining modified routing information based on whether the destination device has moved away from its home region, and
wherein the call is routed to the remote gateway in the remote region based on the destination handset identifier, the remote routing information, and the modified routing information.

20. A method for routing a push-to-talk call, comprising:
determining that a push-to-talk button has been activated to indicate that a call has been initiated;
receiving a destination handset identifier, the destination handset identifier identifying a destination handset, the destination handset identifier including a region identifier identifying a different technological region;
determining remote routing information based on the region identifier, the remote routing information including data necessary for routing the call to the remote region;
routing the call to a remote gateway in the remote region based on the destination handset identifier and the remote routing information if the region identifier identifies the remote region;
receiving modified routing information from the remote gateway; and
routing the call to the destination handset in the local region based on the destination handset identifier and the modified routing information.
